(19) United States
(12) Patent Application Publication
(10) Pub. No.: US 2026/0298118 A1
(43) Pub. Date: Oct. 1, 2026

(54) EXHAUST PIPE STRUCTURE

(71) Applicant: Mazda Motor Corporation, Aki-gun (JP)

(72) Inventors: Shohei Matsuba, Aki-gun (JP); Kouichi Shimizu, Aki-gun (JP); Keisuke Agusa, Aki-gun (JP); Masakazu Tamano, Aki-gun (JP); Yuta Takamura, Aki-gun (JP)

(21) Appl. No.: 19/546,730

(22) Filed: Feb. 23, 2026

(30) Foreign Application Priority Data
Mar. 25, 2025 (JP) 2025-050155

(51) Int. Cl. F01N 1/02; F01N 1/08

(52) U.S. Cl. CPC F01N 1/02; F01N 1/08; F01N 2290/10

(57) ABSTRACT

To enable effective sound production of exhaust sound while suppressing vehicle exterior noise, an exhaust pipe structure includes: an exhaust pipe extending from an engine toward the rear of a vehicle under a floor of the vehicle; a casing (pre-silencer) to which the exhaust pipe is connected and into which a pressure wave of exhaust gas discharged from the engine is released; and a diaphragm (upper wall) designed to have a specific vibration characteristic and emitting sound at a specific frequency by vibrating due to the pressure wave released in the casing.

### TECHNICAL FIELD

The technique disclosed herein relates to an exhaust pipe structure.

### BACKGROUND ART

A conventional vehicle sound system is described in JP6614199B2. The sound system is a system that allows an occupant of a vehicle to actively listen to engine sound and/or exhaust sound.

The sound system includes three openings, first to third, each of which is connected to the inside of a cabin. The first opening is formed in a dash panel on a cabin front side. The second opening is formed in a kick-up portion on a cabin rear side. The third opening is formed in a tunnel portion at a center of the cabin.

The engine sound and/or the exhaust sound causes film members, each of which covers the respective opening, to vibrate, and the engine sound and/or the exhaust sound is thereby effectively transmitted to the inside of the cabin.

The sound system is suitable for mounting on a vehicle, such as a sports car, in which driving enjoyment is emphasized, in order to perform sound production for the occupant.

### SUMMARY

### TECHNICAL PROBLEM

The exhaust sound that is caused by exhaust gas discharged from an engine is mainly reduced by using a silencer. This is to reduce vehicle exterior noise.

However, when the exhaust sound is reduced, it becomes difficult to allow the occupant to actively listen to the exhaust sound, that is, to perform the sound production in the vehicle, the joy of the travel of which is emphasized as described above. The sound production and the reduction in the vehicle exterior noise are conflicting demands.

In addition, for effective sound production, it is preferable to allow the occupant to listen to a sound at a specific frequency, rather than simply increasing the exhaust sound.

The technique disclosed herein enables effective sound production of exhaust sound while suppressing vehicle exterior noise.

### SOLUTION TO PROBLEM

The technique disclosed herein relates to the exhaust pipe structure. The exhaust pipe structure includes an exhaust pipe that extends from the engine toward a rear of the vehicle under a floor of the vehicle; a casing to which the exhaust pipe is connected and into which a pressure wave of the exhaust gas discharged from the engine is released; and a diaphragm that is designed to have a specific vibration characteristic and that emits the sound at the specific frequency by vibrating due to the pressure wave released in the casing.

The exhaust gas discharged from the engine flows through the exhaust pipe. The exhaust pipe is connected to the casing. The pressure wave of the exhaust gas is released into the casing. The casing may have a larger space than the exhaust pipe. The casing into which the pressure wave of the exhaust gas is released can reduce the exhaust sound. The casing suppresses vehicle exterior noise.

The exhaust pipe structure includes the diaphragm. The diaphragm is designed to have the specific vibration characteristic. For example, the diaphragm is designed to have the specific vibration characteristic by adjusting the mass of the diaphragm and/or adjusting the shape of the diaphragm.

The diaphragm vibrates by the pressure wave that is released into the casing. The vibration of the diaphragm emits the sound at the specific frequency. By including the diaphragm having the specific vibration characteristic, the exhaust pipe structure can provide effective sound production for an occupant of the vehicle.

The diaphragm may constitute a part of the casing.

Since the part of the casing that is located under the floor of the vehicle functions as the diaphragm having the specific vibration characteristic, the sound at the specific frequency generated by the vibration of the diaphragm is easily transmitted to the occupant in a cabin. It is possible to effectively perform the sound production for the occupant.

The casing may be located in a tunnel under the floor, and

the diaphragm may constitute an upper wall of the casing.

Since the upper wall of the casing that is located in the tunnel is located immediately below the floor of the vehicle, the sound at the specific frequency generated by the vibration of the upper wall is easily transmitted to the occupant in the cabin. The effect of the sound production is large.

Since the casing is located in the tunnel, the sound at the specific frequency generated by the vibration of the upper wall is blocked by a lateral wall of the tunnel. The sound at the specific frequency generated by the vibration of the upper wall is suppressed from being transmitted to the outside of the vehicle. This structure is advantageous in suppressing the vehicle exterior noise.

The casing may be a pre-silencer that is interposed in the middle of the exhaust pipe between the engine and a main silencer to which a rear end of the exhaust pipe is connected.

The pre-silencer that is interposed in the middle of the exhaust pipe has a silencing function of the exhaust sound. By causing the upper wall of the pre-silencer to function as the diaphragm, the pre-silencer can contribute to both the silencing function of the exhaust sound and the sound production.

Since the pre-silencer is located in an intermediate portion of the vehicle in a front-rear direction, the pre-silencer is separated from a rear end of the vehicle. Even when the upper wall of the pre-silencer generates the sound at the specific frequency, the sound is hardly transmitted to the outside of the vehicle. The vehicle exterior noise is suppressed.

In addition, the pre-silencer that is located in the intermediate portion of the vehicle in the front-rear direction is located near the cabin. The pre-silencer can provide the effective sound production for the occupant.

The diaphragm may include a weight that is attached to a plate surface.

When the weight is attached to the plate surface of the diaphragm, the natural frequency of the diaphragm changes and/or the vibration mode of the diaphragm changes. For example, the vibration characteristic of the diaphragm is adjusted by adjusting the mass of the weight and/or an attachment position of the weight. By using the weight, the frequency of the sound generated by the diaphragm can be adjusted. The two or more weights may be attached to the diaphragm.

The diaphragm may include at least a first portion and a second portion having different vibration characteristics from each other.

Since the diaphragm has at least the first portion and the second portion, the diaphragm can change the frequency of the generated sound according to a position hit by the pressure wave. Since a flow rate of the exhaust gas that flows through the exhaust pipe is changed according to an operation state of the engine, a position at which the pressure wave hits the diaphragm is changed. The sound generated by the diaphragm is changed according to the operation state of the engine. For example, the first portion and the second portion may have different plate thicknesses.

The first portion and the second portion may be aligned in an extending direction of the exhaust pipe.

The flow rate of the exhaust gas that flows through the exhaust pipe is changed according to a magnitude of a speed of the engine. At the low flow rate, the position at which the pressure wave hits the diaphragm in the casing becomes close to an inlet of the casing. At the high flow rate, the position at which the pressure wave hits the diaphragm in the casing is separated from the inlet of the casing and becomes close to an outlet. According to the flow rate of the exhaust gas, the position at which the pressure wave hits the diaphragm in the casing is changed with respect to the extending direction of the exhaust pipe.

The first portion and the second portion are aligned in the extending direction of the exhaust pipe, for example, such that the first portion is located at a position near the inlet of the casing and the second portion is located at a position away from the inlet of the casing. When the engine speed is low, the vibration of the first portion becomes dominant. When the engine speed is high, the vibration of the second portion becomes dominant. The diaphragm can change the generated sound according to the magnitude of the engine speed.

A center axis of the exhaust pipe that is connected to the casing may be located below a center of the casing in an up-down direction, and the diaphragm that constitutes the upper wall may be spaced apart from the exhaust pipe in the up-down direction.

When the exhaust pipe is offset downward with respect to the casing, the distance between the upper wall of the casing, which is formed by the diaphragm, and the exhaust pipe is increased. Due to the pressure wave that is released in the casing, the upper wall vibrates easily. The upper wall can effectively emit the sound at the specific frequency.

The exhaust pipe may include a downstream end that is opened in the casing, and the downstream end of the exhaust pipe may be directed toward the upper wall.

The exhaust gas that is discharged from the downstream end of the exhaust pipe into the casing flows toward the upper wall. Since the vibration of the upper wall of the casing is promoted, the upper wall can effectively emit the sound at the specific frequency.

The exhaust pipe may penetrate the casing in the front-rear direction, and the exhaust pipe may include a plurality of communication holes, each of which communicates between an inside and an outside of the exhaust pipe in the casing. A large number of the communication holes may be formed in an entire peripheral surface of the exhaust pipe.

The exhaust gas that flows through the exhaust pipe is discharged into the casing through the plurality of the communication holes. The exhaust sound is suppressed by dispersing the pressure wave. In addition, with the pressure wave, the upper wall of the casing can effectively emit the sound at the specific frequency.

A partition that is located in the casing and partitions an inside of the casing into at least a first region and a second region may be provided, and the first region may be filled with a sound absorbing material, and the second region may not be filled with the sound absorbing material.

Since a portion of the inside of the casing is filled with the sound absorbing material, the casing can effectively silence the exhaust sound.

The partition may partition the inside of the casing such that the exhaust pipe is located in the first region and the diaphragm is located in the second region.

Since the diaphragm is located in the second region, the sound absorbing material does not inhibit the vibration of the diaphragm. The diaphragm can emit the sound at the specific frequency by vibrating due to the pressure wave. The casing can achieve both a high silencing effect by the sound absorbing material and the sound production by the vibration of the diaphragm.

The exhaust pipe may penetrate the casing in the front-rear direction, and a part of the exhaust pipe that extends in the casing may be located in the first region, and another part of the exhaust pipe may be located in the second region.

Since a part of the exhaust pipe is located in the second region, the part of the exhaust pipe located in the second region is not covered with the sound absorbing material. The diaphragm, which is also located in the second region, effectively vibrates by the pressure wave of the exhaust gas discharged from the exhaust pipe in the second region. The casing can achieve both the large silencing effect by the sound absorbing material and the sound production by the vibration of the diaphragm at a higher level.

The partition may include a vent hole.

The partition does not obstruct the flow of the exhaust gas while restricting a filling area of the sound absorbing material to a part of the inside of the casing. The casing can achieve both the silencing effect of the exhaust sound and the sound production while suppressing an increase in exhaust resistance of the engine.

### ADVANTAGEOUS EFFECTS

The exhaust pipe structure enables the effective sound production while suppressing the vehicle exterior noise.

### BRIEF DESCRIPTION OF DRAWINGS

FIGS. 1A and B include a plan view of an exhaust pipe structure according to a first embodiment and a cross-sectional view that is taken along IB-IB.

FIG. 2 is a view in which a vehicle, to which an exhaust pipe structure according to a second embodiment is applied, is seen from below.

FIG. 3 is a perspective view in which the exhaust pipe structure according to the second embodiment is partially ruptured.

FIGS. 4A and B include a cross-sectional view in which the exhaust pipe structure according to the second embodiment is seen from above, and a cross-sectional view that is taken along IVB-IVB.

FIG. 5 illustrates a measurement result of sound, which is generated in the exhaust pipe structure, in a cabin.

FIG. 6 is a perspective view in which an exhaust pipe structure according to a third embodiment is partially ruptured.

FIGS. 7A and B includes a cross-sectional view in which the exhaust pipe structure according to the third embodiment is seen from above, and a cross-sectional view that is taken along VIIB-VIIB.

FIG. 8 is a perspective view in which an exhaust pipe structure according to a modified example is partially ruptured.

FIGS. 9A and B includes a cross-sectional view in which the exhaust pipe structure according to the modified example is seen from above, and a cross-sectional view that is taken along IXB-IXB.

### DESCRIPTION OF EMBODIMENTS

Hereinafter, embodiments of an exhaust pipe structure will be described with reference to the drawings. The exhaust pipe structure described herein is illustrative.

### First Embodiment

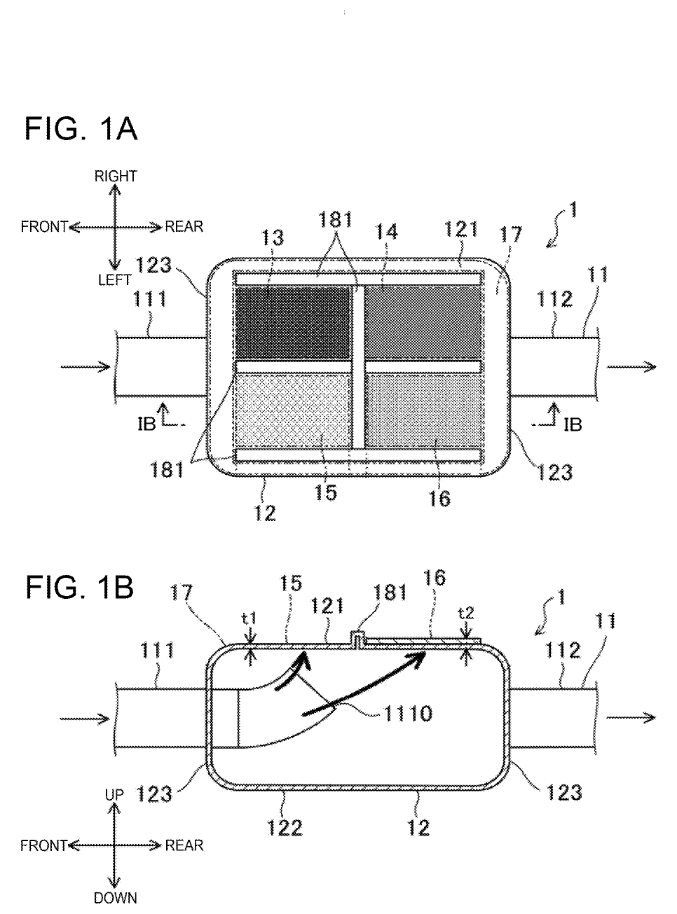

FIGS. 1A and B illustrate a schematic exhaust pipe structure 1. The exhaust pipe structure 1 is mounted on a vehicle. FIG. 1A is a plan view in which the exhaust pipe structure 1 is seen from above, and FIG. 1B illustrates a cross-section that is taken along IB-IB in FIG. 1A.

The exhaust pipe structure 1 includes an exhaust pipe 11. The exhaust pipe 11 is connected to an engine that is mounted on the vehicle. Exhaust gas that is discharged from the engine flows through the exhaust pipe 11. In FIGS. 1A and B, a direction in which the exhaust gas flows is from left to right in the drawing. A left side of FIGS. 1A and B corresponds to the front of the vehicle, and a right side of FIGS. 1A and B corresponds to the rear of the vehicle.

The exhaust pipe structure 1 includes a casing 12. The casing 12 is interposed in the middle of the exhaust pipe 11. More specifically, an upstream exhaust pipe 111 is connected to a side wall 123 on a front side of the casing 12. A downstream end 1110 of the upstream exhaust pipe 111 is located inside the casing 12. An upstream end of a downstream exhaust pipe 112 is connected to a side wall 123 on a rear side of the casing 12.

The casing 12 has an upper wall 121, a lower wall 122, and the four side walls 123. The four side walls 123 vertically connect the upper wall 121 and the lower wall 122.

The casing 12 has a sealed box shape. Each of a height of the casing 12 in an up-down direction, a width thereof in a right-left direction, and a length in a front-rear direction is longer than a diameter of the exhaust pipe 11. The casing 12 has a larger space than the exhaust pipe 11. The right-left direction is a vehicle width direction of the vehicle.

The pulsating exhaust gas that flows through the exhaust pipe 111 is discharged into the casing 12. In the casing 12, a pressure wave of the exhaust gas is released. Since there is a large cross-sectional area difference between the exhaust pipe 111 and the casing 12, the pressure wave expands, and exhaust sound is attenuated.

In addition, in the casing 12, a frequency component of the pressure wave is partially canceled by interference between a traveling wave that travels as is and a reflected wave that is reflected by the wall of the casing 12, and the exhaust sound is attenuated.

The casing 12, which is connected to the exhaust pipe 11, has a function to reduce the exhaust sound. The casing 12 that is mounted on the vehicle reduces vehicle exterior noise.

The casing 12 has not only the function to reduce the vehicle exterior noise but also a function of sound production. The sound production means that a sound at a specific frequency is generated to allow an occupant of the vehicle to actively listen to the exhaust sound.

For the function of the sound production, the upper wall 121 of the casing 12 includes a plurality of portions 13 to 17.

Each of the first portion 13, the second portion 14, the third portion 15, and the fourth portion 16 has a different vibration characteristic. The first portion 13, the second portion 14, the third portion 15, and the fourth portion 16 in the illustrated example have the same area. The first portion 13, the second portion 14, the third portion 15, and the fourth portion 16 may be, for example, portions having different plate thicknesses t from each other (see t1 and t2 in FIG. 1B).

In the upper wall 121, the first portion 13, the second portion 14, the third portion 15, and the fourth portion 16 are arranged in the front-rear direction and arranged in the right-left direction. In the upper wall 121, portions around the first portion 13, the second portion 14, the third portion 15, and the fourth portion 16 constitute a fifth portion 17 that has a different vibration characteristic from those of the first portion 13, the second portion 14, the third portion 15, and the fourth portion 16.

The upper wall 121 also has a bead 181. The bead 181 is located between two each of the first portion 13, the second portion 14, the third portion 15, the fourth portion 16, and the fifth portion 17 to separate the respective portions 13 to 17. The bead 181 has higher rigidity than the respective portions 13 to 17, and is less likely to vibrate than the respective portions 13 to 17.

Being separated by the bead 181, each of the first portion 13, the second portion 14, the third portion 15, the fourth portion 16, and the fifth portion 17 can vibrate with a particular vibration characteristic without being affected by the other portions. By vibrating with the particular vibration characteristic, each of the first portion 13, the second portion 14, the third portion 15, the fourth portion 16, and the fifth portion 17 functions as a diaphragm that emits sound at the specific frequency. The upper wall 121 as a whole also vibrates at a particular vibration characteristic, and thereby functions as a diaphragm that emits sound of a specific frequency.

Each of the first portion 13, the second portion 14, the third portion 15, the fourth portion 16, and the fifth portion 17 of the upper wall 121 vibrates by the pressure wave that is released in the casing 12. By adjusting the vibration characteristic of each of the first portion 13, the second portion 14, the third portion 15, the fourth portion 16, and the fifth portion 17, the upper wall 121 of the casing 12 can generate the sound at the specific frequency that is associated with the exhaust from the engine. Accordingly, the casing 12 can have the function of the sound production that allows the occupant to actively listen to the exhaust sound.

As illustrated in FIG. 1B, in the case where the downstream end 1110 of the exhaust pipe 111 is directed toward the upper wall 121 in the casing 12, the exhaust pipe 111 can discharge the exhaust gas toward the upper wall 121. The upper wall 121 effectively vibrates by the exhaust gas. A sound pressure of the exhaust sound, to which the occupant listens, can be increased, and the exhaust pipe structure 1 can enhance the effect of the sound production.

In addition, a flow rate of the exhaust gas that flows through the exhaust pipe 11 changes between a case where the engine is operated at a low speed and a case where it is operated at a high speed. In the case where the engine is operated at the low speed, and the flow rate is low in terms of the device, as indicated by an arrow in FIG. 1B, the exhaust gas is discharged toward the front portion of the upper wall 121 near an inlet of the casing 12. The first portion 13 and the third portion 15 of the upper wall 12 mainly vibrate by the pressure wave.

In the case where the engine is operated at a high speed, and the flow rate is high in terms of the device, as indicated by an arrow in FIG. 1B, the exhaust gas is discharged toward the rear portion of the upper wall 121 that is located away from the inlet of the casing 12. The second portion 14 and the fourth portion 16 of the upper wall 121 mainly vibrate by the pressure wave.

Which portion vibrates varies by the engine speed. The casing 12 can change the frequency of the sound that is generated when the engine is operated at the low speed and the frequency of the sound that is generated when the engine is operated at the high speed. The exhaust pipe structure 1 can provide the occupant with the advanced sound production that corresponds to an operation state of the engine.

The number of divisions of the upper wall 121 illustrated in FIGS. 1A and B is an example, and the number of divisions of the upper wall 121 is not limited to a specific number.

It can be designed to set the vibration characteristic of the upper wall 121 to a specific vibration characteristic by adjusting the shape and/or the arrangement of each of the first portion 13, the second portion 14, the third portion 15, and the fourth portion 16.

The upper wall 121 may not be divided into the plurality of the portions, and the plate thickness t may be made constant for the entire upper wall 121. When the plate thickness t and/or the shape of the upper wall 121 is designed to have the specific vibration characteristic, the upper wall 121 vibrates with the specific vibration characteristic by the pressure wave that is released within the casing 12, and the casing 12 can emit the sound at the specific frequency.

The upper wall 121 may have the specific vibration characteristic by attaching one or more weights to an upper surface of the upper wall 121.

The upper wall 121 is not limited to a flat plate, and may be an upwardly or downwardly curved plate.

It may be designed by using any of various methods described above that, instead of designing the upper wall 121 of the casing 12 to have the specific vibration characteristic, the lower wall 122 has a specific vibration characteristic. Both of the upper wall 121 and the lower wall 122 of the casing 12 may be designed to have the specific vibration characteristic.

Furthermore, instead of using the wall that constitutes the casing 12 as the diaphragm, the diaphragm that is designed to have the specific vibration characteristic may be arranged inside the casing 12. In addition to the use of the wall constituting the casing 12 as the diaphragm, the diaphragm may be arranged inside the casing 12.

### Second Embodiment

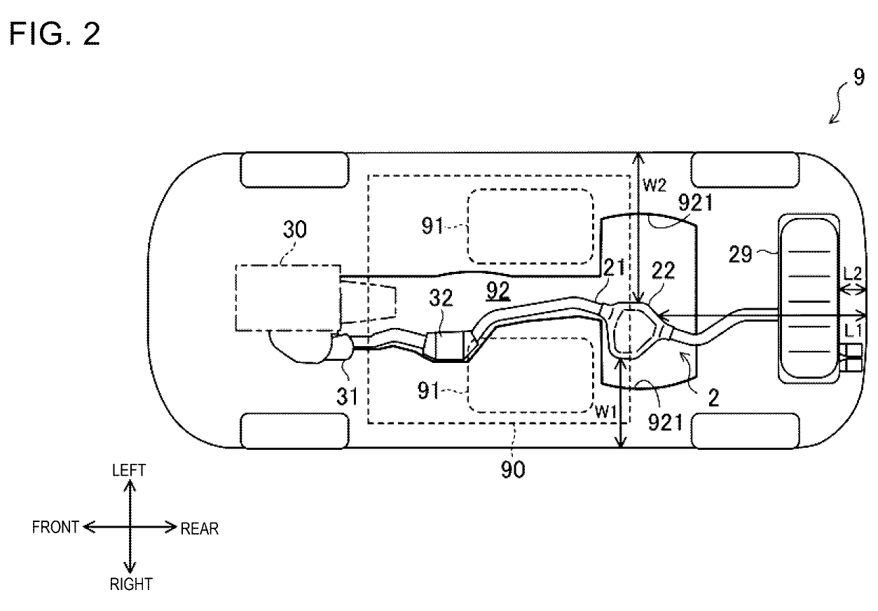

FIG. 2 illustrates a vehicle 9, to which an exhaust pipe structure 2 according to a second embodiment is applied. FIG. 2 illustrates a case where a bottom side of a floor of the vehicle 9 is seen from below, and a lower surface of a pre-silencer 22, which will be described below, is illustrated in FIG. 2.

Similar to the first embodiment, the exhaust pipe structure 2 includes an exhaust pipe 21 and a casing. The casing is the pre-silencer 22.

An engine 30 is located in a front portion of the vehicle 9. The exhaust pipe 21 is connected to the engine 30 and extends to the rear of the vehicle 9. Catalytic devices 31, 32 are interposed in the exhaust pipe 21. Each of the catalytic devices 31, 32 purifies the exhaust gas that is discharged from the engine 30.

A rear end of the exhaust pipe 21 is connected to a main silencer 29. The main silencer 29 is located in a rear end portion of the vehicle 9. The main silencer 29 has a silencing function of the exhaust sound and a sound production function of the exhaust sound. The main silencer 29 has a structure for silencing and a structure for the sound production in the casing by using a larger casing volume than that of the pre-silencer 22.

The pre-silencer 22 is located between the engine 30 and the main silencer 29, and is interposed in the middle of the exhaust pipe 21. Together with the main silencer 29, the pre-silencer 22 silences the exhaust sound. The pre-silencer 22 that is interposed in the middle of the exhaust pipe 21 suppresses generation of a standing wave having a long wavelength by reducing the lengths of the exhaust pipe 21 between the engine 30 and the pre-silencer 22 and the exhaust pipe between the pre-silencer 22 and the main silencer 29.

The pre-silencer 22 is located near a cabin 90 in which the seats 91, 91 are installed.

The exhaust pipe 21 and the pre-silencer 22 are located in a tunnel 92. The tunnel 92 is recessed upward from the bottom side of the floor of the vehicle 9 by the upright walls 921 that are erected in the up-down direction. The tunnel 92 is opened downward.

The tunnel 92 extends rearward from the front portion of the vehicle 9. In the tunnel 92, in addition to the exhaust pipe 21 and the pre-silencer 22, a propeller shaft that transmits power of the engine 30 to the rear wheels is located.

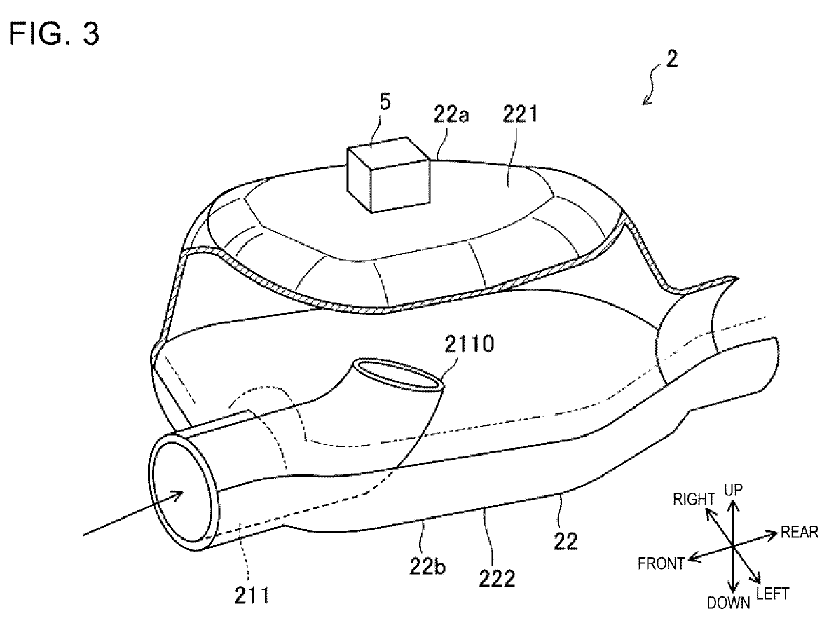

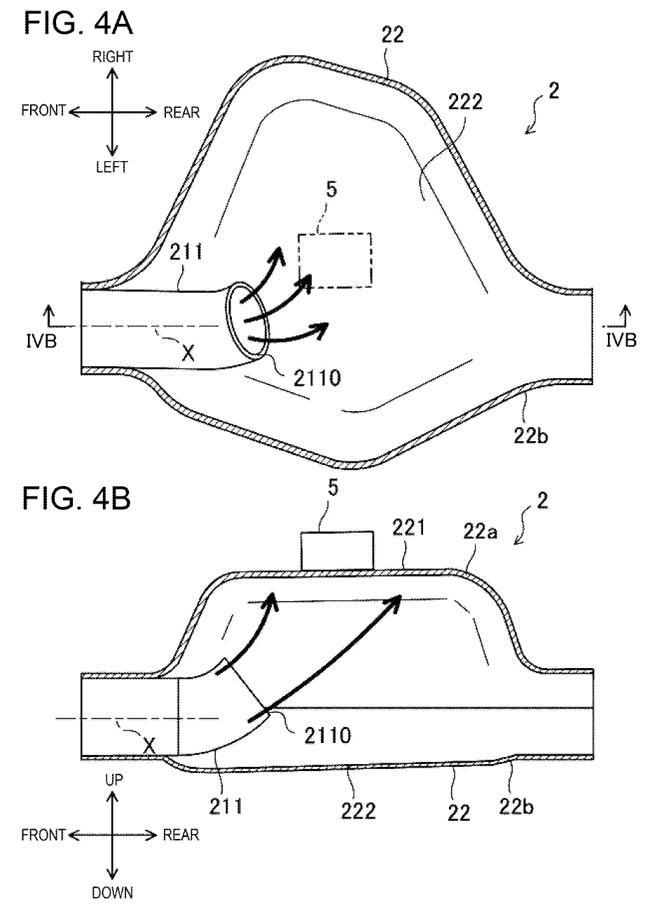

FIG. 3 is a partial perspective view in which the pre-silencer 22 is partially ruptured. FIG. 4A is a cross-sectional view in which the pre-silencer 22 is seen from above, and FIG. 4B illustrates a cross-section that is taken along IVB-IVB in FIG. 4A.

The pre-silencer 22 is formed by superimposing a first shell 22a and a second shell 22b in the up-down direction. The first shell 22a and the second shell 22b comprise the casing of the pre-silencer 22.

The pre-silencer 22 has an upper wall 221 and a lower wall 222. The upper wall 221 extends in the front-rear direction and the right-left direction. The upper wall 221 is a plate that has a substantially pentagonal shape when seen from above. The lower wall 222 opposes the upper wall 221 in the up-down direction and extends in the front-rear direction and the right-left direction. Similarly to the upper wall 221, the lower wall 222 is also a plate that has a substantially pentagonal shape when seen from above. Each of the upper wall 221 and the lower wall 222 is a flat plate. A side wall connects the upper wall 221 and the lower wall 222 in the up-down direction.

An upstream exhaust pipe 211 is connected to the front side wall of the pre-silencer 22. As illustrated in FIG. 4A, a center axis X of the exhaust pipe 211 is located on the left side of a center of the pre-silencer 22 in the right-left direction.

As illustrated in FIG. 4B, the center axis X of the exhaust pipe 211 is located below the center of the pre-silencer 22 in the up-down direction. The exhaust pipe 211 is in the vicinity of the lower wall 222. The upper wall 221 is spaced apart from the exhaust pipe 211 in the up-down direction.

A downstream end 2110 of the exhaust pipe 211 is opened in the pre-silencer 22. As illustrated in FIG. 4A, the downstream end thereof is directed toward a center of the upper wall 221 in the right-left direction. In addition, as illustrated in FIG. 4B, the downstream end is directed toward the upper wall 221.

A weight 5 is attached to the upper surface of the upper wall 221 of the pre-silencer 22. Due to the attachment of the weight 5, the upper wall 221 has a specific vibration characteristic. An attachment position of the weight 5 in the illustrated example is an example, and the weight 5 can be attached at an appropriate position on the upper wall 221. In addition, the mass of the weight 5 can be set appropriately, and a size of the weight 5 in the illustrated example is merely illustrative.

Since it has a larger volume than the exhaust pipe 21, the pre-silencer 22 has a silencing function of the exhaust sound. The vehicle 9 that includes the pre-silencer 22 and the main silencer 29 can significantly suppress the exhaust sound. The vehicle 9 can comply with regulations on the vehicle exterior noise.

The upper wall 221 of the pre-silencer 22 functions as a diaphragm. The upper wall 221 vibrates by the pressure wave that is released in the pre-silencer 22. Since the vibration characteristic of the upper wall 221 is adjusted by the weight 5, the upper wall 221 that vibrates by the pressure wave emits the sound at the specific frequency. Since it can generate a desired exhaust sound, the pre-silencer 22 can have such a sound production function that allows the occupant to actively listen to the exhaust sound.

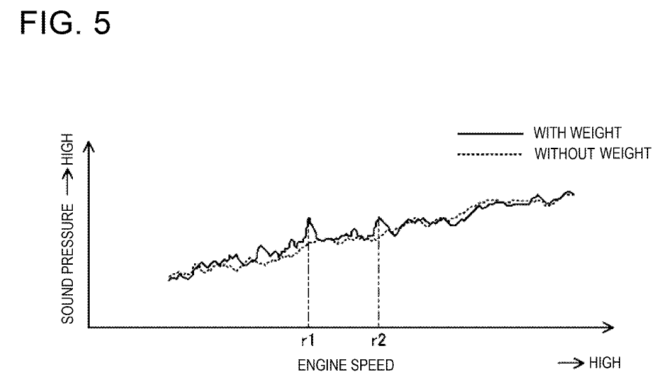

Here, FIG. 5 illustrates a result from actually measuring the sound generated by the pre-silencer 22 in the vehicle 9, on which the pre-silencer 22 illustrated in FIGS. 3 and 4 is mounted. A horizontal axis of FIG. 5 represents a speed of the engine 30, and a vertical axis represents the sound pressure that is measured in the cabin 90. A broken line in FIG. 5 represents a measurement result of the conventional pre-silencer to which the weight 5 is not attached, and a solid line represents a measurement result of the pre-silencer 22 to which the weight 5 is attached. The pre-silencer 22, to which the weight 5 is attached, has a higher sound pressure than the conventional pre-silencer due to occurrence of resonance at each of specific engine speeds r1, r2. The pre-silencer 22, whose vibration characteristic is adjusted by attaching the weight 5, can provide the sound production that allows the occupant to actively listen to the exhaust sound at the specific frequency.

As illustrated in FIG. 2, the pre-silencer 22 is located near the cabin 90. The desired exhaust sound that is generated by the pre-silencer 22 is easily transmitted to the occupant in the cabin 90. The exhaust pipe structure 2 can exhibit the large sound production effect.

The pre-silencer 22 is located near the cabin 90. Thus, even when the sound generated by the pre-silencer 22 is not so loud, the occupant can be made to listen to the exhaust sound. The suppression of the sound generated by the pre-silencer 22 for the sound production is advantageous for the reduction of the vehicle exterior noise.

Unlike the main silencer 29, the pre-silencer 22 is located on a central side of the vehicle 9 in the front-rear direction. Thus, the distance L1 therefrom to a rear end of the vehicle 9 is longer than the distance L2 between the main silencer 29 and the rear end. Distances W1, W2 from the pre-silencer 22 to lateral ends of the vehicle 9 are also relatively long in the right-left direction, that is, the vehicle width direction. The sound generated by the pre-silencer 22 for the sound production is hardly transmitted to the outside of the vehicle.

Furthermore, since the pre-silencer 22 is located in the tunnel 92, the sound generated by the pre-silencer 22 is blocked from being transmitted to the outside of the vehicle by the upright wall 921 that forms the tunnel 92.

Since the upper wall of the pre-silencer 22 is separated from the opening on the lower side of the tunnel 92, the sound generated by the pre-silencer 22 is further suppressed from being transmitted to the outside of the vehicle.

The fact that the pre-silencer 22 has the sound production function can enhance the effect of the sound production on the occupant while reducing the vehicle exterior noise.

In the pre-silencer 22, since the exhaust pipe 211 and the upper wall 221 are spaced apart from each other in the up-down direction, the upper wall 221 can effectively vibrate due to the pressure wave that is released in the pre-silencer 22. The pre-silencer 22 can effectively generate the desired sound.

Since the downstream end 2110 of the exhaust pipe 211 is directed toward the upper wall 221 in the up-down direction, the upper wall 221 can effectively vibrate. In addition, since the downstream end 2110 of the exhaust pipe 211 is directed toward the center of the upper wall 221 in the right-left direction, the upper wall 221 can also effectively vibrate.

As indicated by arrows in FIG. 4B, the discharge direction of the exhaust gas toward the upper wall 221 is changed between the case where the engine 30 is operated at the low speed and the case where it is operated at the high speed. The pre-silencer 22 can change the frequency of the sound that is generated when the engine is operated at the low speed and the frequency of the sound that is generated when the engine 30 is operated at the high speed. Similar to the exhaust pipe structure 1, the exhaust pipe structure 2 can also provide the occupant with the advanced sound production that corresponds to the operation state of the engine 30.

Two or more weights may be attached to the upper wall 221.

### Third Embodiment

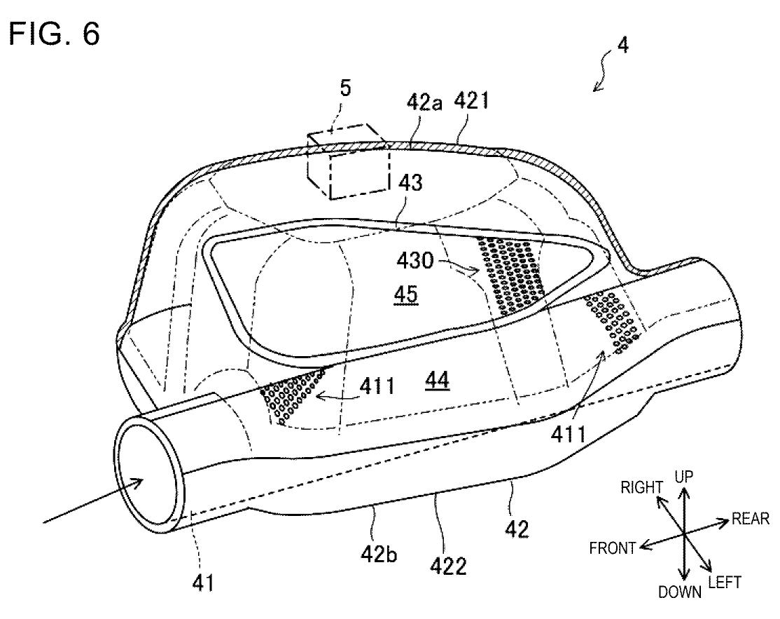

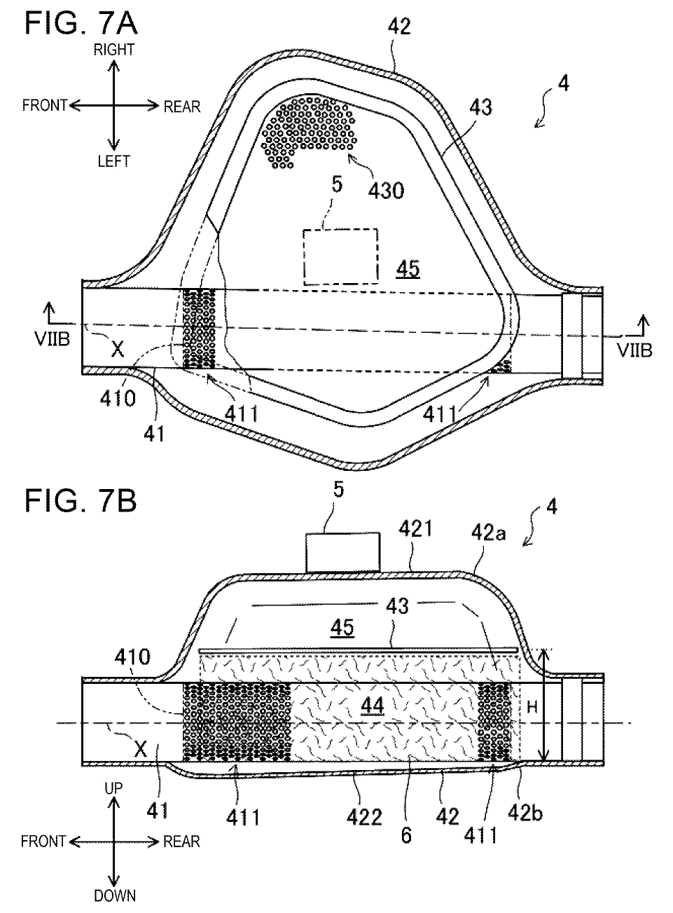

FIG. 6 illustrates an exhaust pipe structure 4 according to a third embodiment. The exhaust pipe structure 4 includes an exhaust pipe 41 and a pre-silencer 42. FIG. 7A is a cross-sectional view in which the pre-silencer 42 is seen from above, and FIG. 7B illustrates a cross-section that is taken along VIIB-VIIB in FIG. 7A.

The pre-silencer 42 is mounted on the vehicle 9 in place of the pre-silencer 22 illustrated in FIG. 2. The pre-silencer 42 is formed by superimposing a first shell 42a and a second shell 42b in the up-down direction. The weight 5 is attached to the upper wall 421 of the pre-silencer 42. The upper wall 421 functions as a diaphragm that emits the sound at the specific frequency.

The exhaust pipe 41 penetrates the pre-silencer 42 in the front-rear direction near a lower wall 422 of the pre-silencer 42. In the pre-silencer 42, the exhaust pipe 41 has a large number of communication holes 411, each of which communicates between the inside and the outside of the exhaust pipe. In a formation region 410 indicated by two-dot chain lines in FIGS. 7A and B, the communication holes 411 are formed over an entire peripheral surface of the exhaust pipe 41. FIGS. 6 and 7 only illustrate some of the communication holes 411. The exhaust gas that flows through the exhaust pipe 41 is discharged into the pre-silencer 42 through the communication holes 411.

The pre-silencer 42 has a partition 43. The partition 43 divides the inside of the pre-silencer 42 into a first region 44 and a second region 45. In the up-down direction, the first region 44 is a lower portion in the pre-silencer 42, and the second region 45 is an upper portion in the pre-silencer 42. The exhaust pipe 41 is located in the first region 44. The upper wall 421 is located in the second region 45.

The partition 43 is a flat plate, a plate thickness of which is relatively thin, and extends in the front-rear direction and the right-left direction according to the shape of the pre-silencer 42. The partition 43 has a large number of vent holes 430. Although only some of the vent holes 430 are illustrated in FIGS. 6 and 7, the vent holes 430 are uniformly formed in the entire partition 43. The vent holes 430 each penetrate the partition 43 in a plate thickness direction.

The first region 44 is filled with a sound absorbing material 6. The sound absorbing material 6 is glass wool, for example. In the pre-silencer 42, a periphery of the exhaust pipe 41 is covered with the sound absorbing material 6. The partition 43 has a function to limit a region filled with the sound absorbing material 6 to the first region 44. The vent holes 430 of the partition 43 do not prevent the flow of the gas between the first region 44 and the second region 45.

Since the exhaust gas is discharged into the pre-silencer 42 through the communication holes 411 of the exhaust pipe 41, the pressure wave is dispersed, and the exhaust sound is suppressed.

In addition, the sound absorbing material 6 covers the periphery of the exhaust pipe 41 that is formed with the communication holes 411. The sound absorbing material 6 that fills the first region 44 further enhances a silencing effect of the pre-silencer 42.

Since the second region 45 is not filled with the sound absorbing material 6 by the partition 43, the sound absorbing material 6 does not inhibit the vibration of the upper wall 421. In addition, since the exhaust pipe 41 is located near the lower wall 422 of the pre-silencer 42, and the exhaust pipe 41 and the upper wall 421 are spaced apart from each other in the up-down direction, a sufficient height of the second region 45 in the up-down direction can be secured. Due to the pressure wave that is released in the pre-silencer 42, the upper wall 421 vibrates easily. The pre-silencer 42 can efficiently generate the desired sound.

Thus, the pre-silencer 42 can achieve both an effect of suppressing the exhaust sound and the sound production at a high level.

Here, in the case where sizes of the first region 44 and the second region 45 are adjusted by adjusting a height position of the partition 43, it is possible to adjust the balance between the effect of suppressing the exhaust sound and the sound production. When a height position H of the partition 43 is raised, and the second region 45 is reduced in size, pressure energy that vibrates the upper wall 421 is attenuated. As a result, the effect of the sound production is degraded, the first region 44 is increased in size, and thus an amount of the glass wool is increased. In this way, the effect of suppressing the exhaust sound is relatively enhanced. When the height position H of the partition 43 is lowered, and the second region 45 is enlarged, the pressure energy that vibrates the upper wall 421 is hardly attenuated. As a result, the effect of the sound production is enhanced, the first region 44 is reduced in size, and thus the amount of the glass wool is reduced. In this way, the effect of suppressing the exhaust sound is relatively lowered.

### Modified Examples

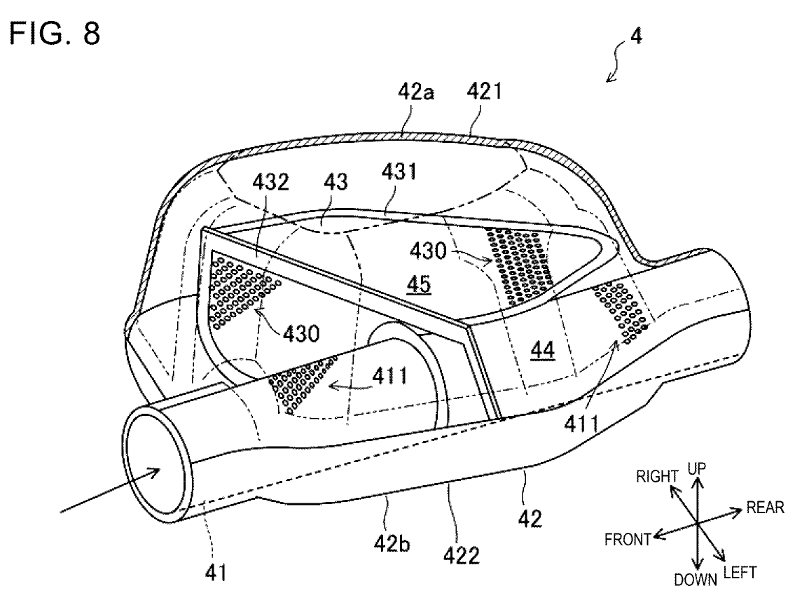

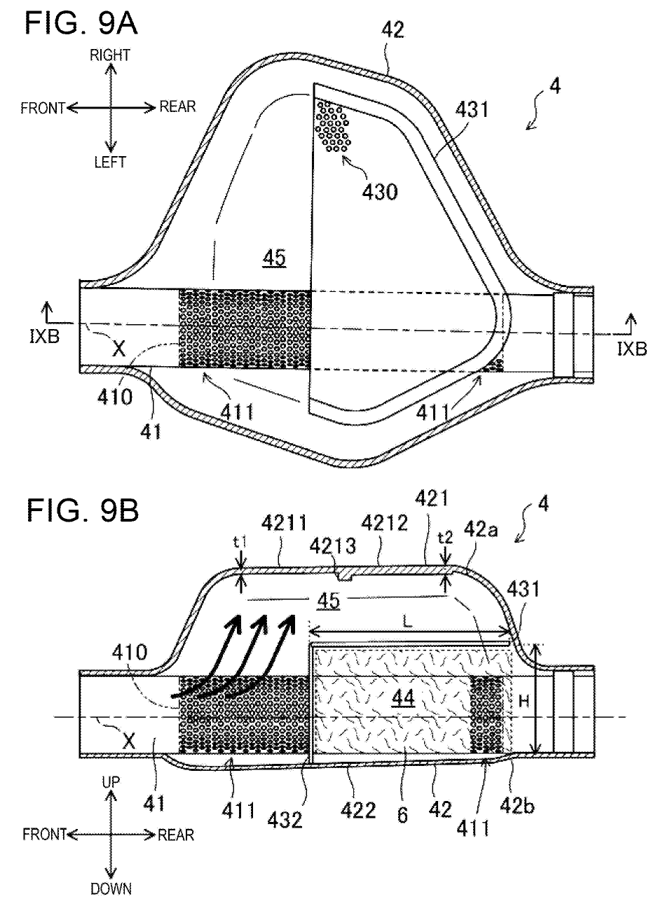

FIGS. 8 and 9 illustrate a modified example of the third embodiment. The partition 43 includes a first partition 431 and a second partition 432. The first partition 431 partitions the inside of the pre-silencer 42 in the up-down direction. The second partition 432 partitions the inside of the pre-silencer 42 in the front-rear direction. More specifically, the second partition 432 is located in a center portion of the inside of the pre-silencer 42 in the front-rear direction. The first partition 431 is located behind the second partition 432, and a front end of the first partition 431 and an upper end of the second partition are joined to each other. The first region 44 is a region that is surrounded by the first partition 431 and the second partition 432. In the pre-silencer 42, the first region 44 is located in a rear portion in the front-rear direction and the lower portion in the up-down direction. The first region 44 is filled with the sound absorbing material 6.

The second region 45 includes a front portion, the rear portion, and the upper portion of the inside of the pre-silencer 42. A front portion of the exhaust pipe 41 is located in the second region 45, and a rear portion of the exhaust pipe 41 is located in the first region 44. The second region 45 is not filled with the sound absorbing material 6. Some of the communication holes 411 formed in the outer peripheral surface of the exhaust pipe 41 are not covered with the sound absorbing material 6.

The weight 5 is not attached to the upper wall 421 of the pre-silencer 42. Similar to the upper wall 121 of the casing 12 illustrated in FIGS. 1A and B, the upper wall 421 includes the first portion 4211 and the second portion 4212. The first portion 4211 is located in a front portion of the upper wall 421, and the second portion 4212 is located in a rear portion of the upper wall 421. The first portion 4211 and the second portion 4212 have different plate thicknesses t1, t2. The first portion 4211 and the second portion 4212 are separated by a bead 4213. The bead 4213 protrudes downward from a lower surface of the upper wall 421, but may protrude upward from an upper surface of the upper wall 421.

Since some of the communication holes 411 of the exhaust pipe 41 are not covered with the sound absorbing material 6, as indicated by an arrow in FIG. 9B, the upper wall 421 as the diaphragm can effectively vibrate by the pressure wave of the exhaust gas that is discharged from the exhaust pipe 41. The pre-silencer 42 can achieve both the large silencing effect by the sound absorbing material 6 and the sound production by the vibration of the diaphragm at the higher level.

In the pre-silencer 42 of the illustrated example, a degree of a sound absorbing effect of the pre-silencer 42 and a degree of the sound production effect can be adjusted by adjusting the height H and the length L of the first region 44. When a volume of the first region 33 is large, the sound absorbing effect is enhanced, and the effect of the sound production effect is degraded. When the volume of the first region 33 is small, the sound absorbing effect is degraded, and the sound production effect is enhanced.

By adjusting diameters, the number, and/or arrangement density of the communication holes 411 of the exhaust pipe 41, which is located in the second region 45, it is possible to adjust a magnitude of an excitation force of the upper wall 421 and to a magnitude of the sound generated by the pre-silencer 42. In addition, a hole axis direction of each of the communication holes 411 is not limited to a direction orthogonal to a center axis X of the exhaust pipe 41, that is, a radial direction of the exhaust pipe 41. For example, a hole axis may be tilted in the front-rear direction with respect to the radial direction. By adjusting the direction of the hole axis of the communication holes 411, the position of the upper wall 421 hit by the pressure wave can be adjusted in the front-rear direction.

By combining the adjustment of the direction of the hole axis of each of the communication holes 411 and the adjustment of the vibration characteristic of the portion hit by the pressure wave in the upper wall 421, the frequency of the sound generated by the pre-silencer 42 can be further finely adjusted.

In the pre-silencer 42 of the illustrated example, the position of the first region 44 is set in the rear portion in the front-rear direction, but the position of the first region 44 in the front-rear direction may be the front portion in the pre-silencer 42. The first region 44 may be an intermediate portion of the inside of the pre-silencer 42 in the front-rear direction.

In the second embodiment and the third embodiment, not only the upper walls 221, 421 but also the lower walls 222, 422 may function as the diaphragms, or both the upper walls 221, 421 and the lower walls 222, 422 may function as the diaphragms. Since the upper walls 221, 421 and the lower walls 222, 422 of the pre-silencers 22, 42 have large areas, they are suitable for the diaphragms.

Instead of causing the upper walls 221, 421 or the lower walls 222, 422 to function as the diaphragms, a diaphragm that vibrates by the pressure wave may be arranged inside each of the pre-silencers 22, 42. In addition, while the upper walls 221, 421 or the lower walls 222, 422 may function as the diaphragms, the diaphragms may be arranged inside the pre-silencers 22, 42.

The technique disclosed herein may be applied to the main silencer 29. In addition, the technique disclosed herein is not limited to the application to the main silencer 29 or the pre-silencers 22, 42.

The various features of each of the embodiments described above can be combined to the extent possible.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### REFERENCE CHARACTER LIST

11 exhaust pipe

12 casing

121 upper wall (diaphragm)

13 first portion

14 second portion

15 third portion

16 fourth portion

21 exhaust pipe

22 pre-silencer

22a first shell (casing)

22b second shell (casing)

221 upper wall (diaphragm)

29 main silencer

30 engine

41 exhaust pipe

411 communication hole

42 pre-silencer

42a first shell (casing)

42b second shell (casing)

421 upper wall (diaphragm)

4211 first portion

4212 second portion

43 partition

430 vent

431 first partition

432 second partition

44 first region

45 second region

5 weight

9 vehicle

92 tunnel

What is claimed is:

1. An exhaust pipe structure, comprising:
an exhaust pipe that extends from an engine toward a rear of a vehicle under a floor of the vehicle;
a casing to which the exhaust pipe is connected and into which a pressure wave of exhaust gas discharged from the engine is released; and
a diaphragm that is designed to have a specific vibration characteristic and that emits sound at a specific frequency by vibrating due to the pressure wave released in the casing.

2. The exhaust pipe structure according to claim 1, wherein
the diaphragm constitutes a part of the casing.

3. The exhaust pipe structure according to claim 2, wherein
the casing is located in a tunnel under the floor, and
the diaphragm constitutes an upper wall of the casing.

4. The exhaust pipe structure according to claim 3, wherein
the casing is a pre-silencer that is interposed in the middle of the exhaust pipe between the engine and a main silencer to which a rear end of the exhaust pipe is connected.

5. The exhaust pipe structure according to claim 4, wherein
the diaphragm includes a weight that is attached to a plate surface.

6. The exhaust pipe structure according to claim 1, wherein
the diaphragm includes at least a first portion and a second portion having different vibration characteristics from each other.

7. The exhaust pipe structure according to claim 6, wherein
the first portion and the second portion are aligned in an extending direction of the exhaust pipe.

8. The exhaust pipe structure according to claim 3, wherein
a center axis of the exhaust pipe that is connected to the casing is located below a center of the casing in an up-down direction, and
the diaphragm that constitutes the upper wall is spaced apart from the exhaust pipe in the up-down direction.

9. The exhaust pipe structure of claim 8, wherein
the exhaust pipe includes a downstream end that is opened in the casing, and
the downstream end of the exhaust pipe is directed toward the upper wall.

10. The exhaust pipe structure according to claim 8, wherein
the exhaust pipe penetrates the casing in a front-rear direction, and
the exhaust pipe includes a plurality of communication holes, each of which communicates between an inside and an outside of the exhaust pipe in the casing.

11. The exhaust pipe structure according to claim 1, further comprising:
a partition that is located in the casing and partitions an inside of the casing into at least a first region and a second region, wherein
the first region is filled with a sound absorbing material, and the second region is not filled with the sound absorbing material.

12. The exhaust pipe structure according to claim 11, wherein
the partition partitions the inside of the casing such that the exhaust pipe is located in the first region and the diaphragm is located in the second region.

13. The exhaust pipe structure according to claim 12, wherein
the exhaust pipe penetrates the casing in a front-rear direction, and
a part of the exhaust pipe that extends in the casing is located in the first region, and another part of the exhaust pipe is located in the second region.

14. The exhaust pipe structure according to claim 11, wherein
the partition includes a vent hole.

15. The exhaust pipe structure according to claim 12, wherein
the partition includes a vent hole.

16. The exhaust pipe structure according to claim 13, wherein
the partition includes a vent hole.
